(19) United States
(12) Patent Application Publication
(10) Pub. No.: US 2013/0104542 A1
(43) Pub. Date: May 2, 2013

(54) EXHAUST GAS RECIRCULATION IN A RECIPROCATING ENGINE HAVING A MULTIPLE-STROKE CONFIGURATION

(71) Applicant: Adam Edgar Klingbeil, Ballston Lake, NY (US)

(72) Inventor: Adam Edgar Klingbeil, Ballston Lake, NY (US)

(73) Assignee: GENERAL ELECTRIC COMPANY, Schenectady, NY (US)

(21) Appl. No.: 13/285,612

(22) Filed: Oct. 31, 2011

(51) Int. Cl. F02B 33/44; F02B 75/02

(52) U.S. Cl. 60/605.2; 123/64

(57) ABSTRACT

An engine comprising at least two cylinders and a turbocharger that includes a turbine operationally attached to a compressor. The intake air for the cylinders is routed through the compressor and exhaust gas from one of the cylinders is recirculated to the air fuel mixture for both cylinders, which exhaust gas from the other cylinder is routed through the turbine, further wherein the first reciprocating cylinder operates on a four-stroke cycle and the second reciprocating cylinder operates on a two-stroke cycle. Methods of operating an engine are disclosed. The present invention has been described in terms of specific embodiment(s), and it is recognized that equivalents, alternatives, and modifications, aside from those expressly stated, are possible and within the scope of the appending claims.

### BACKGROUND OF THE INVENTION

The present invention relates generally to improving emissions on a reciprocating engine and more particularly to an exhaust gas recirculation system for use with a reciprocating engine having a multiple-stroke configuration.

Exhaust gas recirculation (EGR) is a powerful tool for reducing NOₓ emissions substantially in combustion devices (e.g., reciprocating engines) by reducing flame temperature. There are various approaches for employing EGR on a reciprocating engine.

One approach for moving or recirculating the EGR in a two-stroke engine is to use an EGR pump or low-pressure EGR loop with their concomitant control systems. This approach results in additional elements and complexity to the reciprocating engine.

In the event of a four-stroke engine, one approach is to use the back pressure from the cylinders to drive the EGR into the intake system, resulting in decreased complexity However this approach is not directly applicable to two-stroke engines without additional modifications. Embodiments that apply similar approaches are found in U.S. patent application Ser. No. 13/249,843, titled EXHAUST GAS RECIRCULATION IN A RECIRCULATING ENGINE, having a common assignee as the instant application. The entire contents of the application are hereby incorporated by reference.

Accordingly, there is an ongoing need for improving the design of reciprocating engines so as to improve emissions.

### BRIEF DESCRIPTION

The present invention overcomes at least some of the aforementioned drawbacks by providing an EGR configuration for a reciprocating engine that improves upon the current designs. More specifically, the present invention is directed to provide various methods and an engine that provides EGR for a reciprocating engine wherein different cylinders in the cylinder set have multiple stroke configurations (e.g., at least one cylinder operating in a four-stroke configuration and at least one cylinder operating in a two-stroke configuration).

Therefore, in accordance with one aspect of the invention, a method comprises: recirculating exhaust gas from a first cylinder of a reciprocating engine to an intake stream or air-fuel mixture of the first cylinder and a second cylinder of the reciprocating engine; and routing exhaust gas from the second cylinder to a turbine, wherein the first cylinder operates in a four-stroke configuration and the second cylinder operates in a two-stroke configuration.

In accordance with another aspect of the invention, an engine comprises: a first reciprocating cylinder; a second reciprocating cylinder; and a turbocharger comprising a turbine operationally attached to a compressor, wherein intake air for the first reciprocating cylinder and the second reciprocating cylinder is routed through the compressor, further wherein exhaust gas from the first reciprocating cylinder is recirculated to the air or air-fuel mixture for the first reciprocating cylinder and the second reciprocating cylinder, further wherein the exhaust gas from the second reciprocating cylinder operates on a four-stroke cycle and the second reciprocating cylinder operates on a two-stroke cycle.

In accordance with another aspect of the invention, a method comprises: compressing an intake stream or air-fuel mixture; routing the compressed intake steam or air-fuel mixture to a plurality of cylinders of a reciprocating engine; reciprocating a first cylinder of the plurality of cylinders in a four-stroke operating configuration; reciprocating a second cylinder of the plurality of cylinders in a two-stroke operating configuration; recirculating exhaust gas from the first cylinder to the intake stream or air-fuel mixture; and routing exhaust gas from the second cylinder to a turbine.

Various other features and advantages of the present invention will be made apparent from the following detailed description and the drawings.

### BRIEF DESCRIPTION OF THE DRAWINGS

The drawings illustrate one embodiment presently contemplated for carrying out the invention.

FIG. 1 is a schematic diagram of an embodiment of a reciprocating engine incorporating aspects of the present invention.

FIG. 2 is a flowchart depicting an embodiment of a method incorporating aspects of the present invention.

FIG. 3 is a flowchart depicting another embodiment of a method incorporating aspects of the present invention.

### DETAILED DESCRIPTION

Aspects of the present invention have been shown to offer advantages over previous methodologies of exhaust gas recirculation (EGR) for reciprocating engines. The engine and method include a multi-cylinder engine wherein at least one cylinder operates on a two-stroke configuration while at least one other cylinder operates on a four-stroke configuration. In this manner, the four-stroke cylinder(s) acts as donor cylinders such that all of their exhaust is mixed with fresh, intake air. Ultimately, the system for emissions of the reciprocating engine is both improved and simplified.

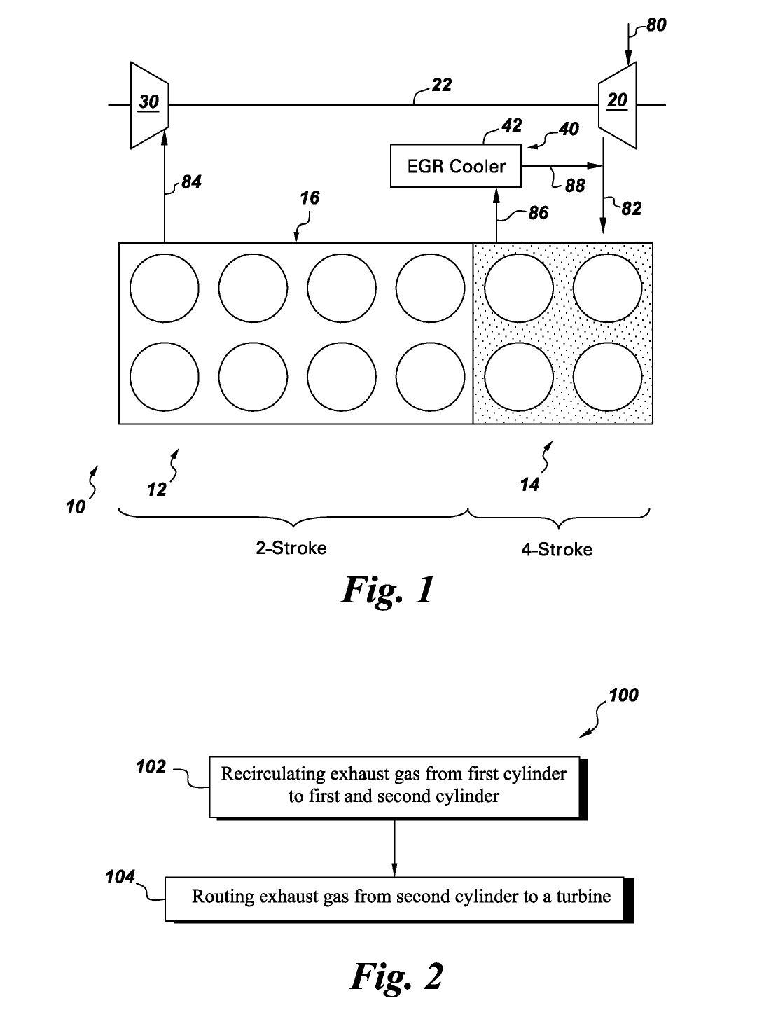

Referring to FIG. 1, a schematic diagram of an embodiment of a reciprocating engine employing aspects of the present invention is shown. The engine 10 comprises a plurality of cylinders 12, of which are at least one donor cylinder 14 and at least one non-donor cylinder 16. The at least one donor cylinder 14 operates in a four-stroke operating configuration and the at least one non-donor cylinder 16 operates in a two-stroke operating configuration. The multiple-stroke configuration for different cylinders may be achieved by suitable valve operating systems.

For illustration purposes only, FIG. 1 shows the engine 10 having a quantity of four donor cylinders 14 and eight non-donor cylinders 16. It should be apparent that virtually any other combination of quantities of donor and non-donor cylinders may be employed without departing from aspects of the present invention. The quantity of donor cylinders 14 and non-donor cylinders may be as small as one cylinder each. Additionally, while FIG. 1 depicts an engine 10 that has a block of four donor cylinders 14 and a block of eight non-donor cylinders 16, various embodiments may have equal quantities of donor and non-donor cylinders. For example, in an embodiment wherein the engine 10 has a V-configuration, one bank of cylinders of the V-shaped engine 10 may be all donor cylinders 14 while the other bank of cylinders of the V-shaped engine 10 may be all non-donor cylinders 16. In this manner, all the cylinders 14, 16, for example, share a common crank shaft, and other elements of the engine 10.

The engine 10 comprises a turbocharger comprising a compressor 20 and a turbine 30. The compressor 20 and the turbine 30 operate on a single shaft 22, such that the rotational energy of the turbine 30 is used to drive the compressors 20. The compressor 20 receives air 80 and supplies compressed air 82 at a pressure to the cylinders 14, 16.

The exhaust gas 86 from the donor cylinders 14 is recirculated and routed through a cooling means 40 to mix via line 88 with compressed air 82 being supplied from the compressor 20 and back to the donor and non-donor cylinders 14, 16. The exhaust gas 84 from the non-donor cylinders 16 is routed to drive the turbine 30. The engine 10 may use additional means to drive the compressor 20 such as, for example, an electric motor or other mechanism which transmits power from the crankshaft 22 to the compressor 20 at a low speed. Such means may be required at start-up and low loads, but may also be beneficial at high loads.

In this embodiment, no external EGR is supplied to both the donor cylinders 14 and the non-donor cylinders 16 via some or all of the exhaust gas of the non-donor cylinders 16.

The cooling means 40 employed may comprise an EGR cooler 42. Alternatively, the cooling means 40 may comprise a liquid injection system (e.g., water), a waste heat recovery devices such as a thermo-electric generator, or a heat exchanger useful for heating or vaporizing some or all of the fuel being supplied to the engine 10.

Various fuel and fuel combinations may be used on embodiments of the engine 10. In an embodiment, all cylinders 14, 16 of the engine 10 may operate on a single fuel or combination of fuels. That is, at a given operating situation, all the cylinders 14, 16 may be operating on the same fuel or combination of fuels. For example, the cylinders 14, 16 may all operate on a single fuel such as diesel fuel, gasoline fuel, and the like. Similarly, the cylinders 14, 16 may all operate on a mixture, or combination of fuels, wherein at least one of fuels of the combination of fuels comprise diesel fuel, gasoline fuel, natural gas, ethanol, syngas, landfill gas, CO/H₂ mixture, and the like.

In another embodiment, the donor cylinder 14 and the non-donor cylinder 16 may each operate on different fuels and/or different fuel combinations. As an example, the cylinder(s) that operate in a four-stroke operating configuration (i.e., donor cylinder 14) may be operating on a first fuel, while the cylinder(s) that operate in a two-stroke operating configuration (i.e., non-donor cylinder 16) may be operating on a second fuel. In another embodiment, the cylinder(s) that operate in a two-stroke operating configuration (i.e., non-donor cylinder 16) may be operating on a single fuel (e.g., diesel), while the cylinder(s) that operate in a four-stroke operating configuration (i.e., donor cylinder 14) may be operating on a combination or mixture of fuels. The mixture or combination of fuels that are combusted in the donor cylinder 14 may comprise diesel and one of natural gas, ethanol, and the like.

Similarly, in another embodiment, the donor cylinder 14 and non-donor cylinder 16 and the engine 10 may be configured such that one or both of the donor cylinder 14 and non-donor cylinder 16 may operate on more than fuel or fuel combination at different times of operation.

Referring to FIG. 2, a flowchart of an embodiment of a method of the present invention is depicted. The method 100 comprises recirculating exhaust gas from a first cylinder to both the first cylinder and a second cylinder of an engine at 102. At 104 exhaust gas from the second cylinder is routed to a turbine of a turbocharger. The first cylinder operates in a four-stroke configuration and the second cylinder operates in a two-stroke configuration.

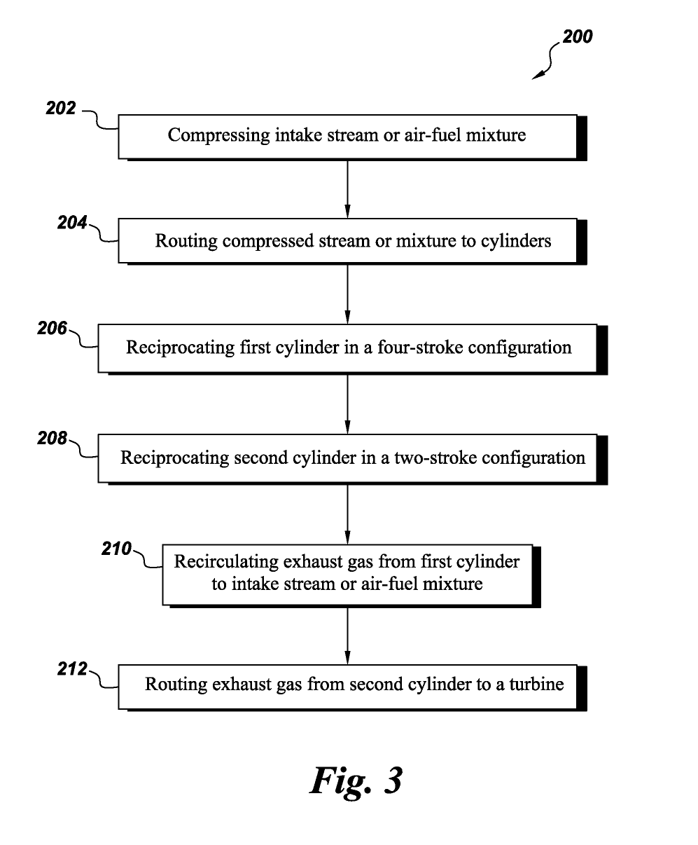

Referring to FIG. 3, a flowchart of another embodiment of a method of the present invention is depicted. The method 200 comprises compressing an intake stream or air-fuel mixture of an engine at 202. At 204 the compressed intake stream or air-fuel mixture is routed to a plurality of cylinders of the engine. At 206 and 208, respectively, a first cylinder is reciprocated in a four-stroke operating configuration and a second cylinder is reciprocated in a two-stroke operating configuration. Exhaust gas from the first cylinder (four-stroke cylinder) is recirculated to the compressed intake steam or air-fuel mixture at 210. Exhaust gas from the second cylinder (two-stroke cylinder) is routed to a turbine, typically of a turbocharger at 212.

While the embodiments illustrated and described herein may be used with a two-stroke configured reciprocating engine, aspects of the present invention may employ other configurations of engines.

Therefore, according to one embodiment of the present invention, a method comprises: recirculating exhaust gas from a first cylinder of a reciprocating engine to an intake stream or air-fuel mixture of the first cylinder and a second cylinder of the reciprocating engine; and routing exhaust gas from the second cylinder to a turbine, wherein the first cylinder operates in a four-stroke configuration and the second cylinder operates in a two-stroke configuration.

According to another embodiment of the present invention, an engine comprises: a first reciprocating cylinder; a second reciprocating cylinder; and a turbocharger comprising a turbine operationally attached to a compressor, wherein intake air for the first reciprocating cylinder and the second reciprocating cylinder is routed through the compressor, further wherein exhaust gas from the first reciprocating cylinder is recirculated to the air or air-fuel mixture for the first reciprocating cylinder and the second reciprocating cylinder, further wherein the exhaust gas from the second reciprocating cylinder is routed through the turbine, further wherein the first reciprocating cylinder operates on a four-stroke cycle and the second reciprocating cylinder operates on a two-stroke cycle.

According to another embodiment of the present invention, a method comprises: compressing an intake stream or air-fuel mixture; routing the compressed intake steam or air-fuel mixture to a plurality of cylinders of a reciprocating engine; reciprocating a first cylinder of the plurality of cylinders in a four-stroke operating configuration; reciprocating a second cylinder of the plurality of cylinders in a two-stroke operating configuration; recirculating exhaust gas from the first cylinder to the intake stream or air-fuel mixture; and routing exhaust gas from the second cylinder to a turbine.

The present invention has been described in terms of the preferred embodiment, and it is recognized that equivalents, alternatives, and modifications, aside from those expressly stated, are possible and within the scope of the appending claims.

What is claimed is:

1. A method comprising:
recirculating exhaust gas from a first cylinder of a reciprocating engine to an intake stream or air-fuel mixture of the first cylinder and a second cylinder of the reciprocating engine; and
routing exhaust gas from the second cylinder to a turbine, wherein the first cylinder operates in a four-stroke configuration and the second cylinder operates in a two-stroke configuration.

2. The method of claim 1 wherein the reciprocating engine operates on diesel fuel.

3. The method of claim 1, wherein the reciprocating engine operates on gasoline fuel.

4. The method of claim 1, wherein the reciprocating engine operates on one of natural gas fuel, syngas, landfill gas, and CO/H₂ mixture.

5. The method of claim 1 wherein the reciprocating engine operates on a plurality of fuels.

6. The method of claim 5, wherein the first cylinder operates on a first fuel, and the second cylinder operates on a second fuel, wherein the first fuel is different than the second fuel.

7. The method of claim 6, wherein at least one of the first fuel and the second fuel comprise a plurality of fuels.

8. The method of claim 7, wherein the plurality of fuels comprise diesel and one of natural gas and ethanol.

9. The method of claim 6, wherein the first fuel comprises only a single fuel and the second fuel comprises a plurality of fuels.

10. The method of claim 9, wherein the first fuel comprises diesel and the plurality of fuels includes diesel.

11. The method of claim 10, wherein the plurality of fuels further comprise one of natural gas and ethanol.

12. The method of claim 11, further comprising cooling the recirculating exhaust gas.

13. The method of claim 12, wherein the cooling is provided by an exhaust gas recirculation cooler.

14. The method of claim 1, comprising:
supplying air to the first cylinder using a first compressor; and
supplying air to the second cylinder using a second compressor.

15. The method of claim 14, comprising:
driving the first compressor with a first turbine; and
driving the second compressor with a second turbine.

16. An engine comprising:
a first reciprocating cylinder;
a second reciprocating cylinder; and
a turbocharger comprising a turbine operationally attached to a compressor, wherein intake air for the first reciprocating cylinder and the second reciprocating cylinder is routed through the compressor, further wherein exhaust gas from the first reciprocating cylinder is recirculated to the air or air-fuel mixture for the first reciprocating cylinder and the second reciprocating cylinder, further wherein the exhaust gas from the second reciprocating cylinder is routed through the turbine, further wherein the first reciprocating cylinder operates on a four-stroke cycle and the second reciprocating cylinder operates on a two-stroke cycle.

17. The engine of claim 16, further comprising an exhaust gas cooling device in fluid communication with the exhaust gas from the first reciprocating cylinder.

18. A method comprising:
compressing an intake stream or air-fuel mixture;
routing the compressed intake stream or air-fuel mixture to a plurality of cylinders of a reciprocating engine;
reciprocating a first cylinder of the plurality of cylinders in a four-stroke operating configuration;
reciprocating a second cylinder of the plurality of cylinders in a two-stroke operating configuration;
recirculating exhaust gas from the first cylinder to the intake stream or air-fuel mixture; and
routing exhaust gas from the second cylinder to a turbine.

19. The method of claim 18, wherein the first cylinder and the second cylinder share a common crankshaft.

20. The method of claim 19, wherein the first cylinder comprises four cylinders and the second cylinder comprises eight cylinders.
